(19) United States
(12) Patent Application Publication
(10) Pub. No.: US 2025/0294307 A1
(43) Pub. Date: Sep. 18, 2025

(54) DIRECTIONAL SPEAKER SYSTEM FOR A PASSENGER CONVEYANCE SYSTEM

(71) Applicant: Otis Elevator Company, Farmington, CT (US)

(72) Inventors: Ergün Alkan, Schönefeld (DE); Andreas Tutat, Berlin (DE)

(21) Appl. No.: 19/078,486

(22) Filed: Mar. 13, 2025

(30) Foreign Application Priority Data
Mar. 15, 2024 (EP) 24163822.0

(51) Int. Cl. H04S 7/00

(52) U.S. Cl. CPC H04S 7/303

(57) ABSTRACT

A passenger conveyance system (100; 200; 300; 400; 500; 600) includes a directional speaker system (106; 206; 306; 406a-c; 506a-b; 606) configured to transmit an audio communication (120a-b; 220a-b; 320a-b; 420a-e) into a restricted target area (110a-b; 310a-b; 410a-b; 610a-c). Using a directional speaker system allows audio communications to be sent to a user (or to multiple users) without broadcasting the message more widely.

### FOREIGN PRIORITY

This application claims priority to European Patent Application No. 24163822.0, filed Mar. 15, 2024, and all the benefits accruing therefrom under 35 U.S.C. § 119, the contents of which in its entirety are herein incorporated by reference.

### TECHNICAL FIELD OF INVENTION

This disclosure relates to a directional speaker system for a passenger conveyance system. In particular, this disclosure relates to a method and apparatus for transmitting audio communications into restricted target areas of a passenger conveyance system using directional speaker systems.

### BACKGROUND OF THE INVENTION

Passenger conveyance systems often need to communicate information to users of the system. For example, elevator systems need to communicate floor information, car information, registration information, alerts, etc. Escalators and/or moving walkways may need to provide warnings as users enter the system or approach the end zone, or they may need to issue a warning when certain user actions are detected (e.g. leaning over a handrail).

### SUMMARY OF THE INVENTION

According to a first aspect, this disclosure provides a passenger conveyance system comprising: a directional speaker system configured to transmit an audio communication into a restricted target area.

According to a second aspect, the disclosure provides a method of transmitting an audio communication into a restricted target area of a passenger conveyance system, comprising: transmitting the audio communication from a directional speaker system into the restricted target area.

The following features are applicable to both the system of the first aspect and the method of the second aspect.

By using a directional speaker system, communications can be sent to a specific, and restricted target area without disrupting or disturbing other users. For example, with a broadcast public address system, all users can hear all messages regardless of who the intended recipient is. While this can work well for a number of generic announcements, it can become intrusive if used to convey messages that are more specific to one user or a particular group of users. For this reason, many systems opt to display user-specific messages on a display, e.g. displaying the identifier of an elevator car that has been allocated to a user. However, displaying information relies on the user paying attention to a display and the message can easily be missed. Using a directional speaker system allows audio communications to be sent to a user (or to multiple users) without broadcasting the message more widely. Thus other users of the system are not disturbed or distracted by messages that are not of interest to them or not relevant to them. Audio communications are also particularly beneficial to visually impaired users. It will be appreciated that relevant information may also be displayed on a visual display if desired (e.g. for hearing impaired users). Therefore, in some examples the system is arranged to transmit a visual communication as well as the audio communication. The visual and audio communications may convey the same information for redundancy, or one communication may supplement the other, e.g. to provide context to the audio communication. For example, the system may send an audio communication to a user instructing them to follow directions displayed on a visual display.

A directional speaker system can be any speaker system that directs the sound in one or more specific directions (as opposed to a broadcast speaker system that transmits in all directions at once). Some directional speaker systems can use mechanical means to focus the transmission of sound and limit the directivity of the transmission to a desired direction. In some examples, phased array speaker systems can be used in which sound is transmitted from several individual speaker elements of the array with a selected delay between those elements such that the sound constructively interferes in a desired beam direction but is attenuated outside of that beam direction. However, due to the wavelength of sounds required for human hearing, such phased array systems may need to have moderately large dimensions in order to provide adequate selectivity. In other examples, modulated ultrasound can be used for directional sound transmission. For example, a parametric array of ultrasonic transducers can be used to generate a carrier wave signal and a modulated signal. The much higher frequency of such ultrasound waves allows them to be far more directional so that a focused and narrow beam of sound can be delivered from a relatively small sized speaker array. By making use of nonlinear interactions, the two transmitted waves can interfere to generate sound in the human auditory range. Thus, audio communication can be restricted to the transmission beam. It will be appreciated that any method or apparatus for creating directional sound may be used in examples of this disclosure. However, the latter technique has certain advantages of size and directivity and thus in some examples, the directional speaker system comprises a parametric ultrasound array.

The directional speaker system can direct sound to a specific and fixed location so that sound will only be heard within that location. Users that enter the location will hear the transmitted sound while users outside the location will not hear the transmitted sound (or at least it will be sufficiently quiet that it is not a disturbance or distraction). However, in some examples the system further comprises a passenger detection system configured to determine a location associated with a user of the passenger conveyance system. By determining a location of the user, the system can direct audio communications to the detected location and thus can direct communications to the detected user. Thus, the system can accommodate users that are not always in the same location and can still direct audio communications appropriately without disturbing other users. In some examples the determined location comprises the head or an ear of the user. With sufficiently narrow sound transmission, the directional speaker can transmit specifically to the head of the detected user or even more specifically to one or both ears of the user. It will be appreciated that narrower and more specific transmission regions will reduce the interference with other users. Passenger conveyance systems can be quite crowded regions and so being able to restrict the target area to a head or an ear reduces the risk of disturbing other users.

In some examples, the passenger detection system is configured to identify a user of the passenger conveyance system. User's may be identified in a variety of ways, e.g. by detecting a smart card or RFID carried by the user, detecting a personal mobile device such as a mobile telephone carried by the user, or by recognising biometrics of the user such as face, fingerprint or gait. By identifying the user, the system can direct audio communications to the user that are based on the identified information or based on registered personal information (e.g. registered in advance and looked up at the time of identification). Such audio communications can be personalised based on the identified or registered personal information. For example, the system may send personalised advertisements to the user or the system may inform a user whether or not they have access to a selected floor. Therefore, in some examples, the system is arranged to transmit personalised audio communications to the user based on their identification.

The restricted target area may enclose the determined location or it may be adjacent to the determined location. For example, the restricted target area may enclose the head of the user so as to allow the user to hear with both ears. In more specific transmissions the restricted area may enclose an ear of the user. At a less restrictive level (e.g. less crowded areas) the restricted target area may encompass a larger area such as the whole of the user or an upper half of a user for more reliability or less precise targeting. In some examples the directional speaker system may effectively create a sound source in a particular region (e.g. due to the nonlinear interactions mentioned above for ultrasonic parametric speaker systems) and therefore the restricted target area may be adjacent to the determined location such that the sound source is audible to the adjacent user.

In some examples, the passenger detection system is arranged to track the location of the user within at least one detection area. By tracking the user, the location of the user can be repeatedly determined and the restricted target area of the directional speaker system can be repeatedly adjusted to correspond to the tracked user. Thus, the audio communication can follow a user as the user moves within the detection area. This is particularly convenient for longer audio communications, e.g. service announcements or informational messages or advertisements. Tracking is also useful for shorter messages where the content of the message may not be known immediately. For example, in a destination call system of an elevator, an elevator car may not be allocated to a user immediately, but rather may be allocated some time after the call once the optimum car has been ascertained. In such cases, the user can be tracked such that the user's location is known at the time that the information becomes available. The audio communication (e.g. advising the user of the allocated car) can then be transmitted specifically to that user's location once available.

It will be appreciated that the detection area may be proximate to the passenger conveyance system, e.g. within part of a lobby or throughout the whole of a lobby. The detection area may also extend further, e.g. along approach corridors or may encompass an entire building floor or multiple floors within a building.

In some examples, the passenger detection system is arranged to detect a position of the body and/or a body part of a user (for example, extremities, especially hands and/or feet). The system may additionally be able to track the body and/or a body part. By detecting (and optionally tracking) the position of the body and/or a body part of the user with respect to components of the conveyance system, the system may be able to detect hazardous cases. For example, if an extremity of a user is within a threshold distance of a hazardous component of the passenger conveyance system, the system may transmit an audio communication to the user warning them of the danger and instructing them to move. If the body or body part is tracked, a warning may be issued if a detected trajectory might lead to a dangerous situation.

In some examples the passenger detection system is arranged to detect one or more user interactions with the passenger conveyance system. User interactions may include physical interactions with elements of the system such as hall call buttons, destination call buttons, buttons on an elevator control panel, interactions with a mobile device, etc. Interactions may also include audio communications from the user such as spoken instructions or requests. Interactions may include gestures from the user such as hand or arm gestures (e.g. pointing, waving, thumbs up, etc.) or gestures of the head (e.g. a nod or shake of the head) or they may include movement of the user in a particular direction. Such interactions may be made to initiate communication with the passenger conveyance system or they may be made in response to an audio communication transmitted to the user, e.g. to provide confirmation of a request or a response to a question.

In some examples, the system is arranged to perform an action in response to the detection of a user interaction with the passenger conveyance system. For example, if the system identifies a user and that user is known to work on the second floor, the system may send an audio communication to the user asking them to nod if their target floor is the second floor. Upon detecting a nod from the user, the system may then reserve an elevator car and send an audio communication to the user informing them of their reserved elevator car number. In another example, if a user is detected to walk away from an elevator after registering a call, an audio communication may ask the user for a confirmation gesture (e.g. a thumbs up signal) to cancel the registered call. Upon detecting the gesture, the system may take action to cancel the call. In another example, the system may ask the user if they would like to hear about a facility in the building. Upon receiving a confirmation from the user, the system may transmit an audio communication to that user (and only that user) with the offered information.

In some examples, the passenger detection system comprises a detector mounted on a ceiling of an elevator car. In some examples, the passenger detection system comprises a detector mounted on a wall of an elevator car. It will be appreciated that a passenger detection system may comprise any number of detectors that may include detectors on the ceiling and/or walls of the elevator car. Due to the space constraints and potentially crowded nature of elevator cars, detectors on the ceiling are in some examples better able to determine user locations due to better line of sight. However, in some examples, detectors on a wall of an elevator car may have better visibility through an elevator car door, e.g. for tracking in and out of the car.

In some examples, the system is arranged to detect obstructions between the directional speaker system and the restricted target area. Obstructions may be problematic for certain types of directional speaker system. In particular, narrow transmission beams (e.g. ultrasonic transmission beams) can be blocked by obstructions and thus the line from a directional speaker system to a target user may become obstructed by another obstruct (especially by another person). By detecting obstructions, the system can avoid transmissions that will not reach their target and can also avoid transmission to unintended targets (e.g. where the obstruction is a non-target user).

In some examples, the system comprises a plurality of directional speaker systems and the system is arranged to select one of the plurality of directional speaker systems to transmit the audio communication into the restricted target area based on the detected obstructions. Thus, where obstructions are detected, another directional speaker system can be employed for increased reliability of transmission so that the target user does not miss the communication.

In some examples, the at least one directional speaker system is mounted on a ceiling of an elevator car. As with the passenger detection system, a speaker system mounted on the ceiling has good line of sight in a potentially crowded elevator car so as to be able to pick out a target user amongst many users. In addition, due to the directional nature of the transmitted beams of sound, transmissions in a downward direction have greater selectivity than horizontal beams which may intersect multiple users' heads.

In some examples, at least one directional speaker systems is mounted on a wall of an elevator car. Directional speaker systems on walls are also beneficial in crowded areas for reaching users that are close to the walls and thus less likely to be obstructed.

In some examples, at least one directional speaker systems is mounted on a ceiling of a lobby. In some examples, at least one directional speaker systems is mounted on a wall of a lobby.

In some examples, the (or multiple) directional speaker system is directed at an angle of at least 30 degrees, at least 45 degrees or at least 60 degrees to the horizontal. In some examples, the (or multiple) directional speaker system is directed at any desired angle. Directing the sound away from the horizontal reduces the chances that a beam will intersect with multiple users' heads. In the event that an audio transmission is not entirely obstructed by the target user, any continuation of the beam will likely rise above or drop below the head of an adjacent user, thereby avoiding unwanted disturbances or distractions.

In some examples, the restricted target area is adjacent to an elevator calling system. An elevator calling system may be a hall call button or a destination call panel or a calling kiosk or the like. In such cases, the restricted target area may be fixed relative to the elevator calling system rather than tracking users. Any user that enters the target area will hear messages transmitted to that area. These may be transmitted periodically, response to user interactions or responsive to detection of a user entering the area. For example, confirmations or assistance messages may be provided to the user as they use the elevator calling system.

In some examples, the restricted target area encloses or is adjacent to an entrance and/or an exit of an escalator or a moving walkway. It is often desired to provide warning messages in such areas as users are about to transition between stationary and moving areas underfoot. Directing such messages to a specific area at the entrance and/or exit without disturbing other users in the vicinity provides improvements to the audio environment while maintain safety around the escalator or moving walkway. In addition, specific messages may be directed at particular users approaching the escalator or moving walkway such as specific assistance messages for disabled users or for users with large baggage.

In some examples the directional speaker system is arranged to transmit audio communications to two or more restricted target areas simultaneously. In particular, with systems that use multiple transmission speakers such as phased array speakers or parametric ultrasound speakers, beamforming techniques can be used to form multiple simultaneous beams in different directions. The same audio communication may be broadcast to multiple users simultaneously (e.g. an announcement that a car has arrived). Such communications avoid disturbing others in the area (e.g. non-users). However, in some examples, the simultaneous audio communications are different audio communications. This is especially advantageous in passenger conveyance systems as there are typically multiple users all needing personalized messages simultaneously. These needs cannot be made with traditional broadcast (e.g. public address) messaging systems, but can be met with directional speaker systems. For example, it becomes possible simultaneously to inform one passenger that their elevator car will arrive in 20 seconds while also informing a different passenger that they should proceed to board elevator car B. Neither passenger is disturbed or distracted by the other's message despite simultaneous transmission. In an escalator system, it may be possible to alert one passenger to the approaching transition zone while alerting a different user to specific arrangements for large luggage with neither passenger being disturbed by the other's message.

In some examples, at least one directional speaker system is mounted in an elevator car and is arranged to transmit an audio communication from inside the elevator car to a restricted target area outside the elevator car. In some examples, at least one directional speaker system is mounted outside an elevator car and is arranged to transmit an audio communication to a restricted target area inside the elevator car. Such systems are particularly advantageous for transmitting audio communications to passengers who may be entering or exiting an elevator car. For example, a passenger may board their elevator car before an informational message about their journey has finished and it is beneficial to be able to continue transmitting that message as the user enters the car. Similarly, a passenger exiting a car may be delivered a personalized audio communication informing them that this is not their destination floor or that they have left their luggage behind. Such messages may need to reach target areas outside the elevator car so as to call the passenger back.

In some examples, the system comprises a plurality of directional speaker systems. As discussed above, there are several reasons for employing multiple directional speaker systems. For example, having directional speakers in multiple locations provides more flexibility to select a transmission path without obstructions and with minimal risk of disturbing other people. Additionally, or alternatively, having multiple directional speakers may allow better coverage of a larger area and may allow a greater number of simultaneous messages to be delivered.

In some examples, the plurality of directional speaker systems comprises a first directional speaker system and a second direction speaker system and the second directional speaker system is arranged to continue an audio communication started by the first directional speaker system. Such systems can track a user as they move within an area or can continue a message despite obstructions appearing (e.g. by handing over to a different directional speaker system). In some examples, one directional speaker system is in an elevator car and another directional speaker system is in an elevator lobby. Thus an audio communication can be begun in a lobby and continued in the car even once the elevator car doors have closed.

The passenger conveyance system may be any suitable system for conveying passengers, but as discussed above and elsewhere in this disclosure, in some examples the passenger conveyance system is an elevator, an escalator or a moving walkway.

### BRIEF DESCRIPTION OF THE DRAWINGS

Certain examples of the present disclosure will now be described with reference to the accompanying drawings in which:

FIG. 1 is a schematic illustration of an elevator car with a directional speaker system in accordance with examples of the present disclosure;

FIG. 2 is a schematic illustration of a passenger conveyance system with a directional speaker system installed in a lobby in accordance with examples of the present disclosure;

FIG. 3 is a schematic illustration of restricted target areas in accordance with examples of the present disclosure;

FIG. 4 is a schematic illustration of a passenger conveyance system with multiple directional speaker systems in accordance with examples of the present disclosure; and

FIG. 5 is a schematic illustration of a passenger conveyance system with a first directional speaker system installed in an elevator car and a second directional speaker system installed in a lobby in accordance with examples of the present disclosure; and

FIG. 6 is a schematic illustration of an escalator with a directional speaker system in accordance with examples of the present disclosure.

### DETAILED DESCRIPTION OF THE INVENTION

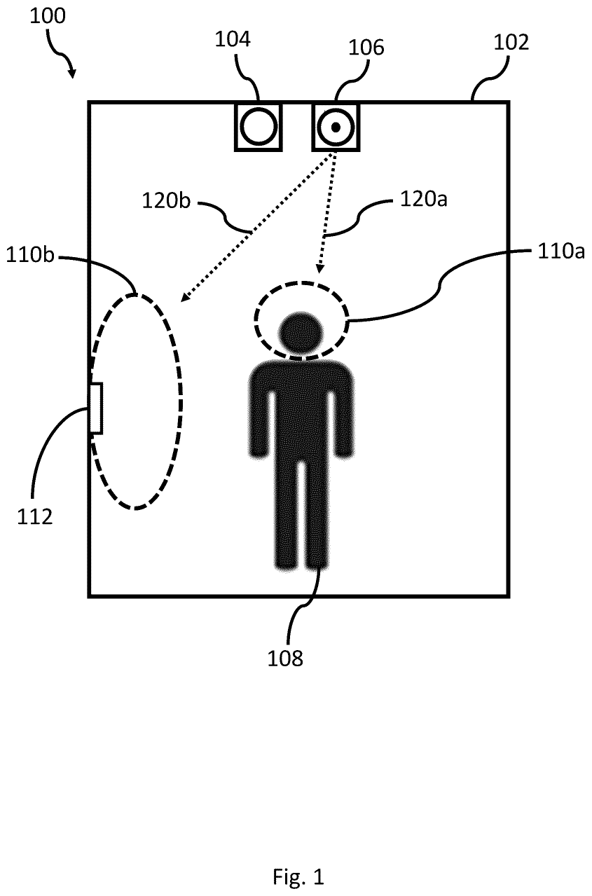

FIG. 1 shows an elevator car 102 of a passenger conveyance system 100. A directional speaker system 106 is installed in the elevator car 102. A passenger detection system 104 is also provided in the elevator car 102. A user 108 of the passenger conveyance system 100 is shown receiving an audio communication from the directional speaker system 106 in a first restricted target area 110a. A second restricted target area 110b is also shown adjacent to an elevator control panel 112.

In the example shown in FIG. 1, the passenger detection system 104 and the directional speaker system 106 are mounted on the ceiling of the elevator car 102. In other examples, they may additionally or alternatively be mounted in other suitable locations such as, the elevator car walls or floor. The passenger detection system 104 may include one or more sensors or detectors such as cameras, depth sensors, infrared sensors, ultrasound sensors, pressure sensors, or the like. The passenger detection system 104 processes the sensor data and determines the location of the user 108 (or, if multiple users are present, it can determine the location of each of them). The determined location of the user 108 can be used to define a first restricted target area 110a around the user's head. The restricted target area may be of any suitable size and shape such that the user can hear audio communications 120a within the restricted target area.

The directional speaker system 106 can be any type of directional speaker system that restricts the audio that it transmits so that the audio is audible only within a given restricted area, while being non-audible (either silent or at sufficiently low volume) outside of that restricted target area. The directional speaker system can thus be used to transmit an audio communication 120a to the restricted target area 110a by transmitting the audio communication 120a so that it is only clearly audible within the first restricted target area 110a. In this way a personalised message can be sent to the user 108.

In some examples, the passenger detection system 104 is capable of tracking the user 108, e.g. as they enter or exit the elevator car 102 and/or as they move around the elevator car 102. In some examples, the passenger detection system 104 can continually determine the location of the user 108. Where the directional speaker system is able to adjust the location of the restricted target area 110a, the restricted target area 110a can then be updated with each newly determined location, thus allowing the directional speaker system 106 to continue transmitting audio communications to the user 108 as they use the passenger conveyance system 100.

Example audio communications include, but are not limited to: alerts that the elevator car 102 is arriving at the user's destination; updates on the estimated time of arrival of a user's car 102 at its destination floor; requests for confirmation (e.g. to confirm a destination floor); instructions (e.g. that a key card is required for the target floor); advertisements and/or building, traffic or weather information.

The passenger detection system 104 may only detect the presence of a user (and optionally track their movement). However, the passenger detection system 104 may also identify users (either via a tag, information provided by the user or via biometric identification such as facial recognition or gait recognition, etc.). Where the user can be identified, the messages can be further tailored to that user. By way of example, messages may be transmitted to the user in a particular language, e.g. the first language of an identified user 108. The passenger detection system 104 may also identify (either automatically or via passenger identification) that a user has a disability and the system can adapt to their needs. For example, if a passenger may struggle to reach a control panel, the directional speaker system 106 can be used to transmit a message suggesting a destination floor and requesting confirmation or providing an alternative input mechanism.

The directional speaker system 106 can thus be used to transmit various types of messages, including messages that apply only to a specific person (which may be alerts or informational or any other type of message).

The directional speaker system 106 shown in FIG. 1 is also capable of transmitting audio communications 120b to the second restricted target area 110b. The second restricted target area 110b is chosen to be a fixed area in front of the elevator control panel 112. The directional speaker system 106 can then transmit audio communications 120b to this area 110b, for example, when a button on the elevator control panel 112 is pressed. As this area is fixed, there is no need to track users 108, although the passenger detection system 104 may still be used to detect that a user 108 has entered the area 110b so as to trigger or enable certain communications 120b. For example, audio feedback from the user's interaction with the control panel 112 can be sent only to the current user of the control panel 112 without disturbing other users.

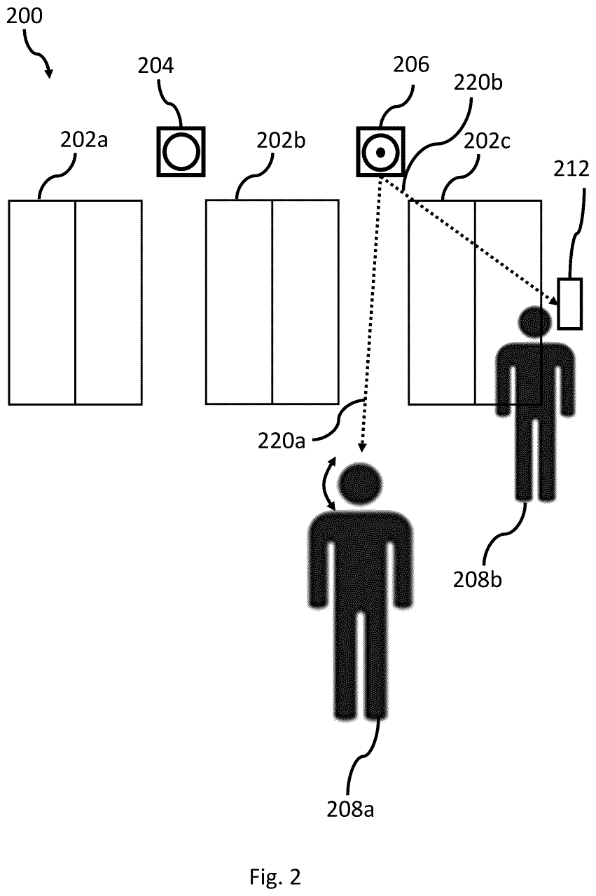

FIG. 2 shows a lobby of a passenger conveyance system 200. A directional speaker system 206 is installed in the lobby. A first elevator car 202a, a second elevator car 202b and a third elevator car 202c are accessible from the lobby. A passenger detection system 204 is installed in the lobby. A directional speaker system 206 is also installed in the lobby. A first user 208a is shown waiting for an elevator car. A second user 208b is shown interacting with an elevator calling system 212. The directional speaker system 206 is shown transmitting a first audio communication 220a to the first user 208a and a second audio communication 220b to the second user 208b adjacent to the elevator calling system 212.

The directional speaker system 206 in this example is capable of sending multiple audio communications to different restricted target areas simultaneously. This is possible with beamforming techniques in which different speaker elements cause constructive interference of a first communication along a first beam and cause constructive interference of a second communication along a second beam. Although there is overlap between the two communications at a particular speaker element, the timing offsets of transmissions at different speaker elements can ensure that each communication is restricted to its respective restricted target area (note that the restricted target areas are not shown in FIG. 2 for clarity, but may be similar to those shown in FIG. 1). The passenger detection system 204 determines the location of each of the users 208a, 208b. The directional speaker system 206 is then arranged to send a first communication 220a to the first user 208a (e.g. a communication about when their reserved car is going to arrive) and a second communication 220b to the second user 208b (e.g. a message informing that the selected floor is restricted and requires a key card). These two communications may be transmitted simultaneously so that only the first user 208a hears the first communication 220a and only the second user 208b hears the second communication 220b.

The second communication 220b may be transmitted to a detected location of the second user 208b or it may be transmitted to a fixed location adjacent to the elevator calling system 212 as discussed in relation to FIG. 1.

The passenger detection system 204 in this example is also arranged to detect user interactions with the system 200. In this example, the directional speaker system 206 can transmit a first audio communication 220a to the first user 208a asking them to nod if their target floor is the seventh floor. If the first user 208a nods to confirm this, the passenger detection system 204 is arranged to detect this confirmation and can relay the confirmation to the elevator system so as to enter the call. The directional speaker system 206 can then transmit a further audio communication to the first user 208a, e.g. informing them of their car reservation and its estimated time of arrival. A user interaction is not restricted to nodding. The passenger detection system 204 may detect other interactions such as hand gestures (pointing, waving or the like) or it may detect button presses on a virtual panel.

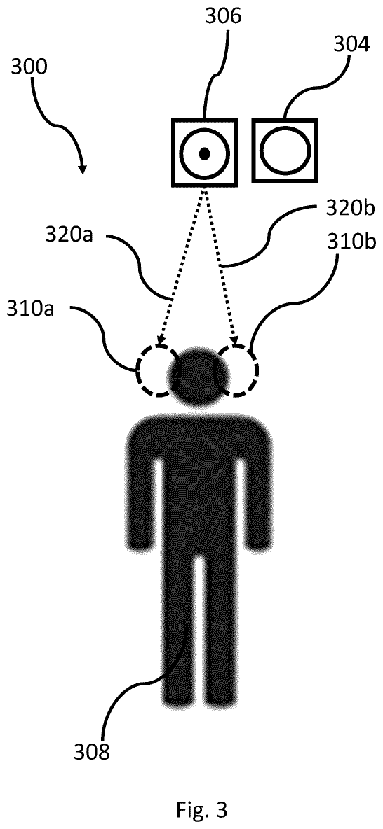

FIG. 3 is an illustration of restricted target areas 310a and 310b according to examples of the present disclosure. In this example, the passenger detection system 304 can determine the location of the user 308. Specifically, the determined location of the user may include the location of each of the user's ears. Two restricted target areas 310a and 310b can then be defined, each around one of the user's ears. When the directional speaker system 306 transmits an audio communication to the determined location of the user, it can transmit the audio communication to each of the restricted target areas 310a and 310b simultaneously. Specifically, it can transmit a first audio communication 320a to the first restricted target area 310a and a second audio communication 320b to the second restricted target area 310b. If one of the restricted target areas 310a or 310b is obstructed from the directional speaker system 306, for instance by another passenger (not shown) obstructing the line of sight between the direction speaker system 306 and one of the user's ears (e.g. area 310b) then the directional speaker system 306 may be controlled not to transmit audio communications to the second restricted target area 310b so as not to risk the message being intercepted by the obstructing passenger and thus avoiding disturbing them. This allows increased directivity and selectivity in the messaging system.

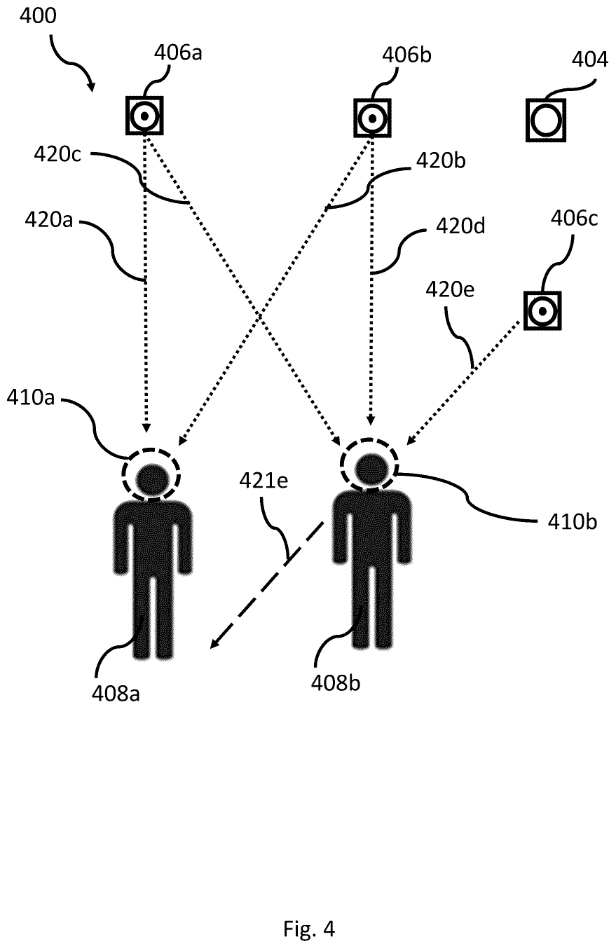

FIG. 4 is an illustration of a passenger conveyance system 400 with multiple directional speaker systems 406a, 406b and 406c according to examples of the present disclosure. FIG. 4 shows a passenger detection system 404, a first directional speaker system 406a, a second directional speaker system 406b, a third directional speaker system 406c, a first user 408a of the passenger conveyance system, a second user 408b of the passenger conveyance system, a first restricted target area 410a and a second restricted target area 410b.

In this example, the passenger detection system 404 determines the location of each user 408a and 408b (and optionally tracks them as they move). A first restricted target area 410a is then defined around the head of the first user 408a and a second restricted target area 410b is defined around the head of the second user 408b.

The first and second directional speaker systems 406a and 406b transmit audio communications to both users 408a and 408b via their respective restricted target areas 410a and 410b. The third directional speaker system 406c only transmits audio communications to the second user 408b via the second restricted target area 410b.

In some examples, the audio communications transmitted by different directional speaker systems 406a, 406b and 406c to the same restricted target area 410a and 410b may contain the same message. These audio communications then provide robustness against obstructions. For example, the first user 408a may receive the same communication simultaneously from both the first and second direction speaker systems 406a, 406b, specifically receiving a first audio communication 420a from the first directional speaker system 406a and a second audio communication 420b from the second directional speaker system 406b (the first and second audio communications 420a, 420b being the same). The second user 408b may receive the same communication simultaneously from the first, second and third directional speaker systems 406a, 406b, 406c (as a third audio communication 420c, a fourth audio communication 420d and a fifth audio communication 420e, all three of which are the same).

In some examples, as the users 408a and 408b move throughout the passenger conveyance system 400 (e.g. around one or more lobbies and/or one or more cars), the passenger detection system 404 updates their determined locations. For example, if the first restricted target area 410a is to be sent an audio communication, the passenger conveyance system 400 detects any obstructions between each directional speaker system 406a, 406b and 406c and the first restricted target area 410a. It then selects which directional speaker system 406a, 406b or 406c (or which combination of them) it would be appropriate to send the audio communication from based on the detected obstructions between each directional speaker system 406a, 406b and 406c and the first restricted target area 410a.

In another example, the system 400 can be arranged to transfer an audio communication from one directional speaker system to another, e.g. to continue an audio communication as the user 408a, 408b moves through the system 400. For example, if a thirty second audio advertisement is chosen to begin transmitting to the first user 408a from the first directional speaker system 406a and the first user 408a moves to a position where that transmission bath is obstructed before the advertisement is completed, the third directional speaker system 406c can be controlled to continue transmitting the audio communication to the first user 408a as there is no obstruction on the intervening path. It will be appreciated that in this arrangement the third directional speaker system 406c will take over the communication from the point at which the obstruction was detected, i.e. the content of the transmission continues uninterrupted, only the source of audio transmission changes.

Although the position of the passenger detection system 404 and the directional speaker systems 406a, 406b, 406c in FIG. 4 is highly schematic, the height of the third directional speaker system 406c relative to the users 408a, 408b illustrates a useful arrangement. In particular, the third directional speaker system 460c is arranged to project its audio communications downwardly at an angle of about 50 degrees to the horizontal. As the projected audio is directed at an angle to the horizontal, it continues to change height after passing the target head of user 408b and thus has a low probability of being audible by any other persons in the area. The continuation path of the audio communication 420e is shown by arrow 421e in FIG. 4 and it can be seen that the audible beam of sound rapidly descends to ground level and will not interfere with any other persons of similar height. It will be appreciated that the same effect can be achieved by directing sound upwardly at an angle to the horizontal.

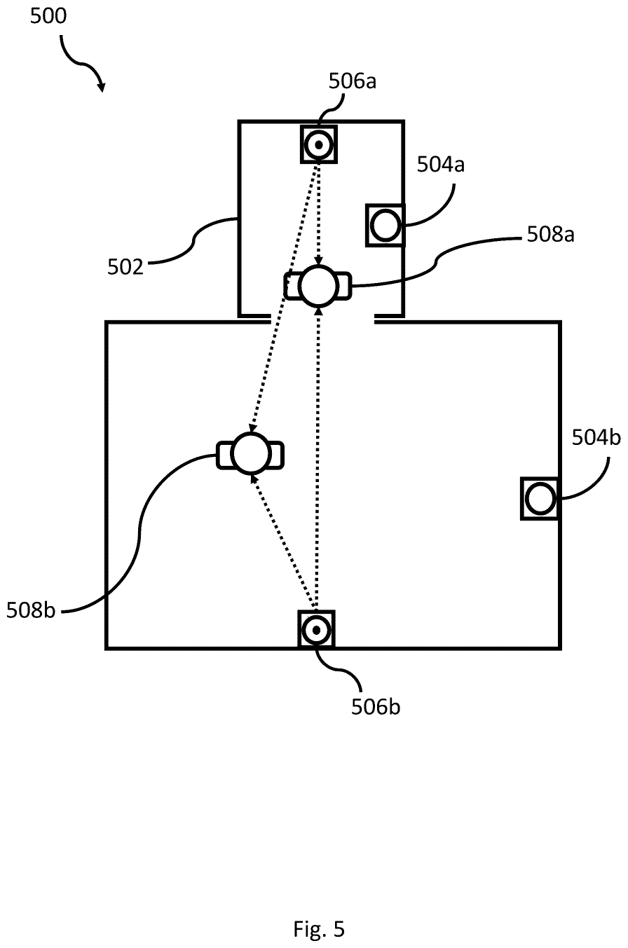

FIG. 5 is a top-down view of a passenger conveyance system 500 with a first directional speaker system 506a installed in an elevator car 502 and a second directional speaker system 506b installed in a lobby.

FIG. 5 shows an elevator car 502, a first passenger detection system 504a, a second passenger detection system 504b, a first directional speaker system 506a, a second directional speaker system 506b, a first user 508a of the passenger conveyance system and a second user 508b of the passenger conveyance system. Restricted target areas are omitted for clarity, but may be as shown and discussed in relation to any of the previous figures.

The first directional speaker system 506a is mounted on a back wall of the elevator car 502 with a field of view that encompasses the elevator doorway (the elevator car doors and the landing doors have been omitted for clarity). Thus the first directional speaker system 506a is capable of transmitting an audio communication from its position within the elevator car 502 to a first user 508a inside the elevator car 502 and also to a second user 508b in the lobby. Similarly, the second directional speaker system 506b is mounted in the lobby on a wall that faces the elevator doorway and is capable of transmitting an audio communication from its position in the lobby to a first user 508a in the elevator car 502 and a second user 508b in the lobby.

With this arrangement, each of the directional speaker systems 506a, 506b has the capability of transmitting past the boundary of the elevator door. Thus each of the directional speaker systems 506a and 506b can better hand off audio communications between each other. For instance, as the first user 508a exits the elevator car 502 and begins to enter the lobby, the first directional speaker system 506a can continue to transmit to the first user 508a and possibly complete its transmission in the lobby, or alternatively has overlapping coverage with the second directional speaker system 506b in which a hand off can occur such that the second directional speaker system 560b can finish the audio communication in the lobby. The same applies to audio communications begun by the second directional speaker system 506b in the lobby which can finish the transmission when the user 508b has moved into the car, or can hand over the transmission in the overlapping area with the first directional speaker system 506a. The ability to transmit across the boundary may be particularly beneficial in certain circumstances such as where a passenger is either entering or exiting a car that they should not. For example, a passenger may attempt to leave the car at the wrong floor or may attempt to enter a car that will not serve their destination floor. If the passenger detection system 504a or 504b detects circumstances such as these, a warning communication may begin in one area (lobby or car) and finish in the other area (car or lobby respectively).

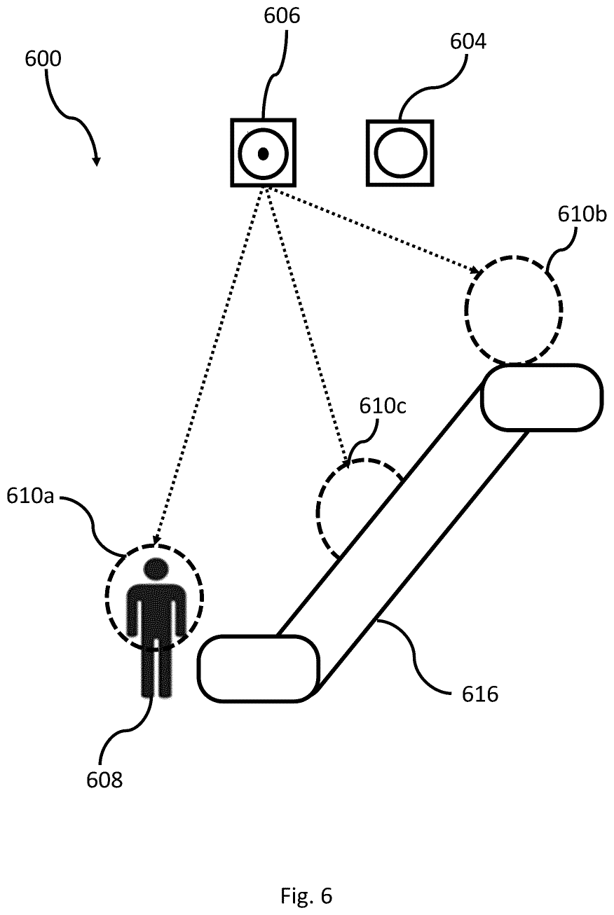

FIG. 6 is an illustration of an escalator 616 with a directional speaker system 606 according to examples of the present disclosure. In this example, the passenger conveyance system 600 includes a passenger detection system 604 and a directional speaker system 606. FIG. 6 also shows a user 608 of the passenger conveyance system 608, a first restricted target area 610a a second restricted target area 610b and a third restricted target area 610c.

In this example, the first restricted target area 610a is in a fixed location at the entrance of the escalator 616 and the second restricted target area 610b is in a fixed location at the exit of the escalator 616. The passenger detection system 604 determines the location of the user 608. When the location of the user 608 is within the first restricted target area 610a, the directional speaker system 606 transmits an audio communication to the user 608, e.g. warning them to be careful when stepping onto the escalator 616. Similarly, when the location of the user 608 is within the second restricted target area 610b, the directional speaker system 606 transmits an audio communication to the user 608 warning them to be careful when stepping off the escalator 616. A third restricted target area 610c may be dynamic (rather than fixed) so that its location is dependent on the location of the user 608 determined by the passenger detection system 604. By way of example, this third restricted target area 610c may be used when a user 608 is detected as leaning dangerously over a handrail of the escalator 616 and may trigger a warning message to the user 608. As with the elevator systems described above, transmitting each of these messages to a restricted area means that other passengers or other non-passengers in the area are not disturbed by communications that are not relevant to them. It will of course be appreciated that the examples described here in relation to an escalator are equally applicable to a moving walkway.

It will be appreciated by those skilled in the art that this disclosure has been illustrated by describing one or more specific examples thereof, but is not limited to these examples; many variations and modifications are possible, within the scope of the accompanying claims.

What is claimed is:

1. A passenger conveyance system comprising:
a directional speaker system configured to transmit an audio communication into a restricted target area.

2. A passenger conveyance system as claimed in claim 1, wherein the directional speaker system is an ultrasonic parametric speaker system.

3. A passenger conveyance system as claimed in claim 1, wherein the system further comprises a passenger detection system configured to determine a location associated with a user of the passenger conveyance system,
optionally wherein the determined location comprises the head or an ear of the user.

4. A passenger conveyance system as claimed in claim 3, wherein the passenger detection system is further configured to identify the user of the passenger conveyance system,
optionally wherein the system is arranged to transmit personalized audio communications to the user based on their identification.

5. A passenger conveyance system as claimed in claim 2, wherein the passenger detection system is arranged to track the location of the user within at least one detection area.

6. A passenger conveyance system as claimed in claim 2, wherein the passenger detection system is arranged to detect one or more user interactions with the passenger conveyance system,
optionally wherein the system is arranged to perform an action in response to the detection of a user interaction with the passenger conveyance system.

7. A passenger conveyance system as claimed in claim 1, wherein the system is arranged to detect obstructions between the directional speaker system and the restricted target area;
wherein the system comprises a plurality of directional speaker systems; and
wherein the system is arranged select one of the plurality of directional speaker systems to transmit the audio communication into the restricted target area based on the detected obstructions.

8. A passenger conveyance system as claimed in claim 1, wherein at least one directional speaker system is mounted on a ceiling of an elevator car.

9. A passenger conveyance system as claimed in claim 1, wherein the restricted target area is adjacent to an elevator calling system.

10. A passenger conveyance system as claimed in claim 1, wherein the directional speaker system is arranged to transmit audio communications to two or more restricted target areas simultaneously.

11. A passenger conveyance system as claimed in claim 1, wherein at least one directional speaker system is mounted in an elevator car and is arranged to transmit an audio communication from inside the elevator car to a restricted target area outside the elevator car; and/or
wherein at least one directional speaker system is mounted outside an elevator car and is arranged to transmit an audio communication to a restricted target area inside the elevator car.

12. A passenger conveyance system as claimed in claim 1, wherein the system comprises a plurality of directional speaker systems.

13. A passenger conveyance system as claimed in claim 12, wherein the plurality of directional speaker systems comprises a first directional speaker system and a second direction speaker system and wherein the second directional speaker system is arranged to continue an audio communication started by the first directional speaker system.

14. A passenger conveyance system as claimed in claim 1, wherein the passenger conveyance system is an elevator, an escalator or a moving walkway.

15. A method of transmitting an audio communication into a restricted target area of a passenger conveyance system, comprising:
transmitting the audio communication from a directional speaker system into the restricted target area.
